(19) United States
(12) Patent Application Publication
(10) Pub. No.: US 2002/0195728 A1
(43) Pub. Date: Dec. 26, 2002

(54) Register with humidifier and deflector for same

(76) Inventor: Blaise M. Wooderson, Olathe, KS (US)

Correspondence Address: HOVEY, WILLIAMS, TIMMONS & COLLINS, 2405 Grand, Suite 400, Kansas City, MO, 64108, US

(21) Appl. No.: 09/885,826

(22) Filed: Jun. 20, 2001

(51) Int. Cl. B01F 3/04

(52) U.S. Cl. 261/102; 261/104

(57) ABSTRACT

A floor vent register and room humidifier comprising a main body with a liquid trough located proximate an air passageway; a wick disposed at least partly in the trough and extending at least partly into the passageway and operable to draw water from the trough towards the passageway; a removable grill protecting the wick and providing access to the wick and trough; and a deflector coupled to the grill for altering the direction of flow of the air exiting the grill.

### BACKGROUND OF THE INVENTION

1. Field of the Invention

The present invention relates to an air register having a built-in room humidifier. The invention further concerns a humidifying floor register having an air deflector.

2. Description of the Prior Art

Room humidifiers have become a necessity in regions where significantly low relative humidity is prevalent, such as regions having extended winter periods. Excessive skin dryness and frequent static electricity shocks are undesirable consequences of such low humidity levels. Accordingly, room humidifiers have been developed to eliminate such concerns by providing a means for raising humidity levels to achieve optimum comfort.

Room humidifiers of varying complexity are known in the art. A sophisticated and costly humidification system can be installed for use with an existing forced-air heating system. This type of system requires an electrical feed, a control system, and a water line tap in order to operate, and will provide humidification for a number of rooms. Another form of humidifier is the portable electric device which includes a water-holding reservoir and an electric fan for circulating humidified air throughout a room. Another device for raising room humidity levels consists of a receptacle which contains a water-holding reservoir and a filter and is designed for placement over a floor heat register. The bottom of the filter maintains contact with the water and the remainder of the filter remains damp as a result of capillary attraction. Room humidity levels are raised as air discharges from the floor register and passes through the filter.

Devices of the prior art, however, have several notable drawbacks. The humidifier designed for use with an existing heating system can be very difficult to install. And significant ongoing maintenance is usually required. The portable room humidifier is typically noisy when in operation. Both the portable room humidifier and the floor register humidifying unit can be rather bulky in structure and thus present a somewhat unfavorable addition to the decor of a room. Further, such devices can present a safety hazard if placed in high traffic areas where occupants are likely to stumble over such devices. Finally, the floor register unit must be temporarily removed in order to adjust the damper to regulate the air flow through the register, which could be a strenuous endeavor if the water reservoir is completely full.

### SUMMARY OF THE INVENTION

In accordance with an embodiment of the present invention, an air register with humidifier is provided. The air register comprises a body, a wick, and a rib. The body defines a flow passageway and includes a trough configured to hold a liquid. The wick includes a first portion projecting into the flow passageway and second portion extending at least partly into the trough. The rib contacts the wick in the trough to at least partly inhibit shifting of the wick in the trough.

In accordance with another embodiment of the present invention, an air register with humidifier for use with a floor vent is provided. The air register comprises a trough and a flow passageway. The trough extends at least partly below the surface of the floor and into the floor vent. The flow passageway allows for air charged to the floor vent to flow therethrough. The trough includes an outer wall spaced from the flow passageway and an inner wall proximate the floor passageway. The outer wall has an upper portion which converges towards the inner wall at a first angle of severity. The outer wall has a lower portion which converges towards the inner wall at a second angle of severity that is greater than the first angle of severity.

In accordance with a further embodiment of the present invention, a deflector couplable to an air register and operable to alter the flow direction of the air exiting the register is provided. The deflector comprises a deflection wall adapted to extend at least partly over the outlet of the air register. The deflection wall includes a lower terminal edge The deflector presents a generally planar bottom surface formed at least in part by the lower terminal edge. A tab is protrudes generally downward from the lower terminal edge of the deflection wall. A leg protrudes generally downward from the bottom surface. A foot is coupled to the leg and extends in a direction generally transverse to the direction from which the leg extends from the bottom surface. The tab, leg, and foot cooperate to couple the deflector to the air register.

In a still further embodiment of the present invention, an air register comprising a body, a wick, a grill, and a deflector is provided. The body defines a flow passageway and includes a trough configured to hold a liquid. The wick has a first portion extended at least partly into the flow passageway and a second portion extending at least partly into the trough. The grill is releasably coupled to the body and extends at least partly over the flow passageway and the trough. The deflector is coupled to the grill and operable to alter the direction of flow of the air exiting the grill.

In a yet further embodiment of the present invention, a method of humidifying a room having a floor vent is provided. The method includes positioning a room humidifying assembly so that it is supported on the floor surface and extends at least partly into the floor vent below the floor surface. The method further includes positioning a wick in a trough of the assembly so that the wick contacts a rib in the trough to thereby at least partly inhibit shifting of the wick in the trough.

### BRIEF DESCRIPTION OF THE DRAWINGS

A preferred embodiment of the present invention is described herein with reference to the following drawing figures:

FIG. 1 is an assembly view of an air register with humidifier and air deflector in accordance with a preferred embodiment of the present invention;

FIG. 2 is plan view of the air register with the air deflector being removed and certain sections of the grill being cut away to more clearly illustrate various features of the body of the register;

FIG. 3 is a cross sectional view taking a long line 3-3 of FIG. 3 which illustrates the air register with humidifier and air deflector being positioned in a floor vent; and

FIG. 4 is a cross sectional view taking along line 4-4 in FIG. 2 illustrating the coupling of the air deflector to the grill with portions being cutting away to better illustrate to the interface of the deflector and grill.

### DETAILED DESCRIPTION OF THE PREFERRED EMBODIMENT

Turning initially to FIG. 1, a room humidifying assembly 10 in accordance with an embodiment of the present invention is illustrated. Room humidifying assembly 10 is similar in design to the room humidifying assembly described in U.S. Pat. No. 5,922,248 issued Jul. 13, 1999, the entire disclosure of which is expressly incorporated herein by reference. Broadly, room humidifying assembly 10 includes a body 12, a wick 14, a grill 16, and a deflector 18.

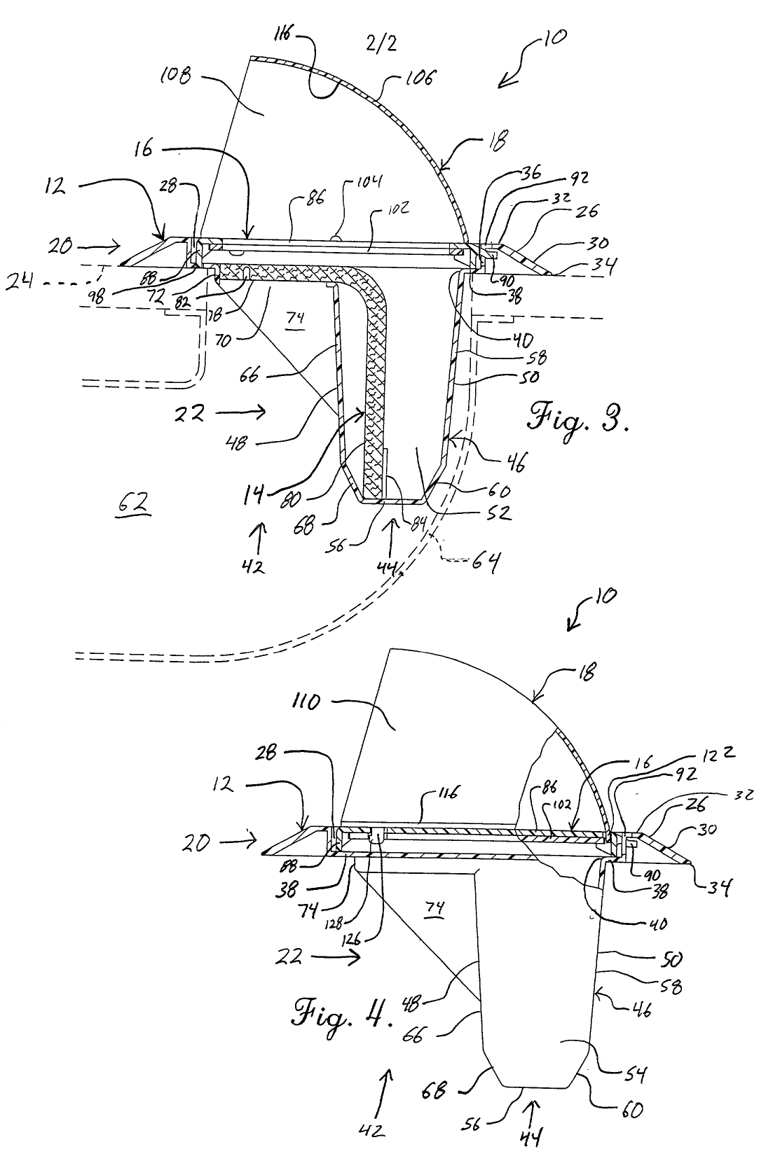

Referring now to FIGS. 3 and 4, body 12 is preferably integrally formed of a synthetic resin material. Body 12 can generally be described in terms of an upper superstructure 20 and a lower substructure 22. As best seen in FIG. 3, superstructure 20 is configured to be disposed above a floor surface 24 while substructure 22 is configured to be disposed below floor surface 24.

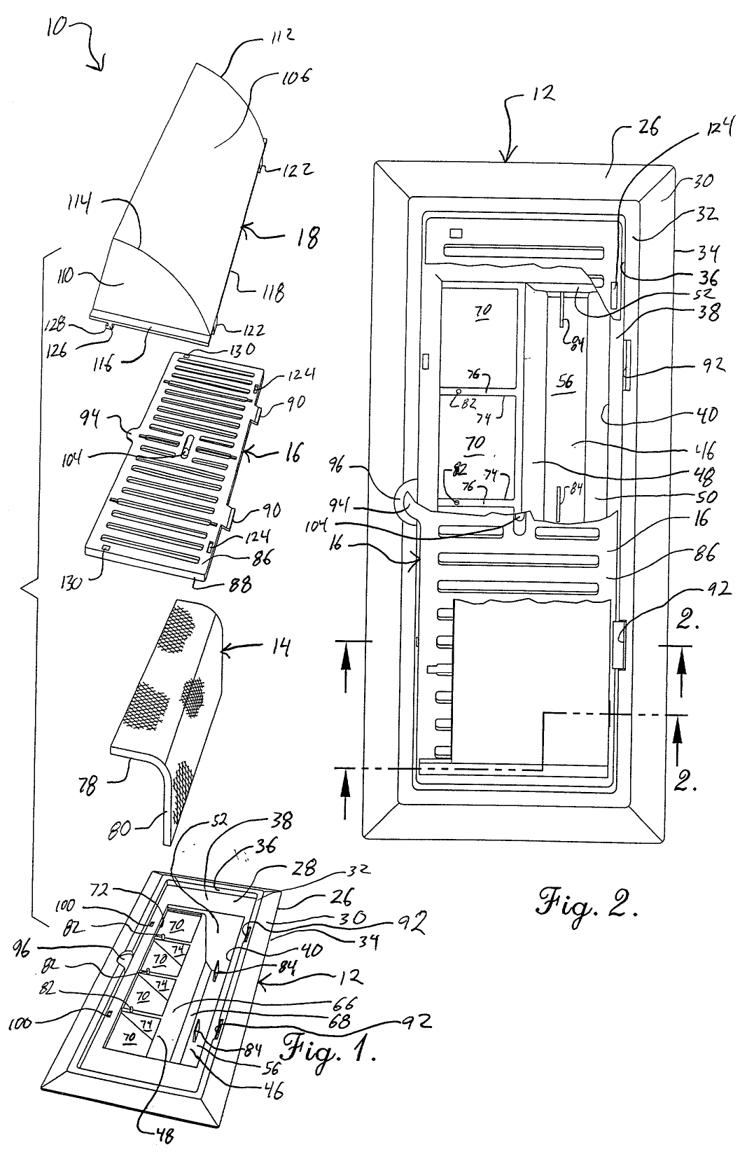

Referring now to FIGS. 1-4, superstructure 20 generally includes a flange 26 and a recess 28. Flange 26 is generally rectangular in shape and continuously circumscribes recess 28. Flange 26 includes a sloped wall 30 and top wall 32. At the bottom of sloped wall 30 is and engagement edge 34 which engages floor surface 24 to thereby at least partly support room humidifying assembly 10 on floor surface 24. Sloped wall 30 extends upwardly and inwardly from engagement edge 34 and joins with top wall 32. A recess wall 36 extends generally downward from the inner edge of top wall 32 to thereby define the outer perimeter of generally rectangular recess 28. Coupled to the bottom of recess wall 36 and extending inwardly therefrom is a recess ledge 38. The outer perimeter of recess ledge 38 is defined by recess wall 36. An inner perimeter 40 of recess ledge 38 defines a generally rectangular opening which provides access to sub-structure 22.

As perhaps best seen in FIGS. 3 and 4, substructure 22 can generally be described in terms of a vent-side portion 42 and a trough-side portion 44. Both vent-side portion 42 and trough-side 44 are coupled to and extend generally downwardly from the bottom of recess ledge 38 proximate inner perimeter 40.

Trough-side portion 44 of substructure 22 generally includes a trough 46 which is capable of hold a liquid, preferably water. The top of trough 46 presents a generally rectangular upper opening which is bounded on three sides by inner perimeter 40 of recess ledge 38. The upper opening in trough 46 is bounded on the fourth side by the top edge of an inner wall 48 of trough 46. Inner wall 48, an outer wall 50, opposing end walls 52 and 54, and a base 56 cooperate to form trough 46. Inner wall 48 is located proximate vent-side portion 42. Outer wall 50 is spaced from vent-side portion 42. End walls 52 and 54 and outer wall 50 extend generally downward from respective portions of inner perimeter 40 of a recess ledge 48. Inner wall 40 is coupled to and extends between end walls 52 and 54 on the side of trough 46 opposite outer wall 50. Base 56 is sealingly coupled to the bottom edges of inner wall 48, outer wall 50, and opposing end walls 52 and 54.

In accordance with an embodiment with the present invention, outer wall 50 includes an upper angled portion 58 and a lower angled portion 60. Upper angled portion 58 converges toward inner wall 48 at a first angle of severity. Lower angled portion 60 converges towards inner wall 48 at a second angle of severity. The second angle of severity is greater than the first angle of severity. As used herein, the term “angle of severity” means an angle measure between a wall or surface of room humidifying assembly 10 and a line or plane extending perpendicular to floor surface 24. As best seen in FIG. 3, the sloped configuration of outer wall 50 allows trough 46 to extend as far downward as possible into a vent shaft 62, thereby maximizing the quantity of liquid which can be stored in trough 46. If outer wall 50 of trough 46 were not configured as described herein, the quantity of liquid which could be stored in trough 46 would be dramatically reduced because the depth of trough 46 would need to be reduced in order to avoid interference with an outer duct wall 64 of ventilation shaft 62. Although outer wall 50 of trough 46 is shown in the drawing figures as including a relatively flat upper angled portion 58 and a relatively flat lower angled portion 60, it is contemplated by the present invention that outer wall 50 could be curved to provide a smooth transition between upper angled portion 58 and lower angle portion 60. It is further contemplated by the present invention that a cross section of inner wall 48, base 56, and outer wall 50 (similar to that shown in FIG. 3) could be generally U-shaped to provide a smooth transition between inner wall 48, base 56, and outer wall 50. Preferably, inner wall 48 is shaped so that it is substantially a mirror image of outer wall 50, with a top angled portion 66, a bottom angled portion 68, and bottom angled portion 68 having a greater angle of severity than top angled portion 66.

Referring again to FIGS. 1-4, vent-side portion 42 of substructure 22 defines air passageways 70 which are adjacent trough 46. Air passageways 70 are defined on three sides by a lip 72 which extends generally downward from the portion of inner perimeter 40 that does not define a portion of the upper opening of trough 46. A plurality of support members 74 extend from inner wall 48 of trough 46 to lip 72. Support members 74 are operable to at least partially support trough 46 relative to recess ledge 36. Support members 74 are preferably generally triangular in shape and present a top surface 76 extending along a plane which is at least substantially perpendicular to the normal direction of air flow through air passageways 70.

Referring now to FIGS. 1 and 3, wick 14 generally includes an upper portion 78 and a lower portion 80. Upper portion 78 is configured to extend at least partially, preferably substantially, over air passageways 70 so that a substantial portion of the air passing through air passageways 70 must pass through upper portion 78. Lower portion 80 is configured to extend generally downwardly into trough 46. Preferably, the lower end of lower portion 80 is located proximate base 56 so that even when trough 46 contains only a minimal amount of liquid, lower portion 80 contacts the liquid. Wick 14 is operable to conduct a liquid stored in trough 46 from lower portion 80 to upper portion 78 by capillary attraction. Preferably, wick 14 is formed of lamented layers of expanded cellulose material.

It is preferred that wick 14 be well supported relative to body 12 so as to maintain wick 14 in a generally L-shaped configuration, with upper portion 78 extending substantially over air passageway 70 and lower portion 80 extending substantially downward into trough 46. Referring now to FIGS. 1-3, a wick-supporting structure including a plurality of pins 82 and plurality of ribs 84 operates to maintain wick 14 in its desired position relative to body 12. Ribs 84 are fixedly coupled to base 56 of trough 46 and extend generally upward into trough 46 between outer wall 50 and inner wall 48. Lower portion 80 of wick 14 can be placed against ribs 84 to restrain wick 14 from its natural tendency to flatten out from the desired L-shaped position. Pins 82 are configured to be inserted into upper portion 78 of wick 14 to restrain wick 14 from shifting relative to air passageways 70.

Referring again to FIGS. 1-4, grill 16 is configured to be removably received in recess 28 of body 12 and includes a plurality of openings therein to allow air to pass generally upwardly therethrough. Grill 16 includes a generally rectangular cover plate 86 bounded by a circumscribing lip 88 extending downwardly from the outer perimeter of cover plate 86. The bottom edge of lip 88 contacts recess ledge 38 and supports grill 16 on recess ledge 38 when grill 16 is coupled to body 12. Tabs 90 extend generally outwardly from one side of lip 88 and are configured to be releasably received in slots 92 of body 12. An opposite side of cover plate 86 includes a projecting handle 94 which is configured to be received at least partly in a groove 96 in body 12. As best seen in FIG. 3, catches 98 extend generally outward from the bottom of lip 88 on the same side of cover plate 86 as handle 94 and are configured to be releasably received in openings 100 in body 12. Referring again to FIGS. 104, grill 16 further includes a dampener 102 which is slidably coupled to the bottom of cover plate 86. Dampener 102 includes openings which correspond to the openings in cover plate 86 so that when dampener 102 is shifted, via a knob 104, into an open position, the slots in cover plate 86 and dampener 102 are generally aligned to allow air to flow therethrough. When dampener is shifted into a closed position, the corresponding openings in cover plate 86 and dampener 102 are misaligned so that dampener 102 at least partially covers the openings in cover plate 86 to thereby inhibit the flow of air through grill 16. Grill 16 is preferably formed of a durable synthetic resin material.

In order to couple grill 16 to body 12, tabs 90 are inserted into slots 92 and grill 16 is pivoted downward by handle 94 until catches 98 are received in openings 102. To decouple grill 16 from body 12, handle 94 can be grasped and raise to remove catches 98 from openings 100. Grill 16 can then be pivoted upwards by handle 94 to a raised position. Once in the raised position, tabs 90 can be removed from slots 92 to decouple grill 16 from body 12.

Deflector 18 generally comprises a deflection wall 106 and a pair of opposing sidewalls 108 and 110 coupled to respective ends 112 and 114 of deflection wall 106 and extending generally downward therefrom. Mounting flanges 116 are coupled to the bottom edge of respective sidewalls 110 and 112 and extend generally transverse to the plane along which sidewalls 108 and 110 extend. Deflection wall 106 is configured to cover a portion, preferably a substantial portion, of cover plate 86. Deflection wall is operable to alter the direction of flow of air passing upwardly through the openings cover plate 86. Deflection wall 106 preferably presents a curved inner deflection surface 116 for contacting the air exiting grill 16. Deflection wall 116 presents a lower terminal edge 118 which is at least substantially co-planar with the bottom of mounting flange 116. Projections 122 extend generally downwardly from lower terminal edge 118 and are configured to be received in apertures 124 of grill 16. Protrusions 126 extend generally downward from the bottom of mounting flange 116. Protrusions include a foot portion 128 which extends transversely to the direction in which protrusions 126 extend from mounting flange 116. Foot portion 128 is configured to be snapped into openings 130 in grill 16 to thereby couple deflector 18 to grill 16. Deflector 18 can be formed of any suitable synthetic resin material.

To assemble room humidifying assembly 110, wick 14 is placed in body 12 so that lower portion 80 is received in trough 46 and rests against ribs 84. Upper portion 78 of wick 14 is placed on top surfaces 76 of support members 74 with pins 82 being inserted at least partly into wick 14 to prevent wick 14 from pulling away from air passageways 70. After wick 14 is placed in body 20 in a generally L-shaped configuration, grill 16 can be coupled to body 12 as described above. Once grill 16 is coupled to body 12, a bottom surface of grill 16 contacts upper portion 78 of wick 14 to prevent upper portion 78 of wick 14 from raising out of contact with pins 82. Thus, upper portion 78 of wick 14 is at least partially compressed between the bottom surface of grill 16 and top surface 76 of support members 74 when grill 16 is coupled to body 12. Deflector 18 can then be coupled to grill 16 by inserting projections 122 into apertures 124 and extending feet 128 of protrusions 126 into openings 130.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the doctrine of equivalents to determine and assess the reasonably fair scope of the present invention as pertains to any apparatus not materially departing from but outside the literal scope of the invention as set forth in the following claims.

What is claimed is:

1. An air register with humidifier, said air register comprising:
a body defining a flow passageway and including a trough configured to hold a liquid;
a wick having a first portion projecting into the flow passageway and a second portion extending at least partly into the trough; and
a rib contacting the wick in the trough to at least partly inhibit shifting of the wick in the trough.

2. An air register as claimed in claim 1; and
a support member coupled to the trough and extending at least partly along the flow passageway,
said support member presenting a top surface.

3. An air register as claimed in claim 2; and
a pin protruding from the top surface and extending at least partly into the wick.

4. An air register as claimed in claim 3,
said rib and said pin cooperating to at least partly inhibit shifting of the wick relative to the body.

5. An air register as claimed in claim 3; and
a grill releasably coupled to the body and extending at least partly over the flow passageway and the trough.

6. An air register as claimed in claim 5,
said grill presenting a bottom surface which contacts the first portion of the wick when the grill is coupled to the body.

7. An air register as claimed in claim 6,
said grill, said rib, and said pin cooperating to at least partly maintain the wick in a generally L-shaped configuration.

8. An air register as claimed in claim 1; and
a grill releasably coupled to the body and extending at least partly over the flow passageway and the trough.

9. An air register as claimed in claim 7,
said grill and said body configured to provide access to the wick and the trough when the grill is removed from the body.

10. An air register with humidifier for use with a floor vent, said air register comprising:
a trough adapted to extend at least partly below the surface of the floor and into the floor vent; and
a flow passageway for allowing air to flow through the air register,
said trough including an outer wall spaced from the flow passageway and an inner wall proximate the flow passageway,
said outer wall having an upper portion which converges towards the inner wall at a first angle of severity,
said outer wall having a lower portion which converges towards the inner wall at a second angle of severity,
said second angle of severity being greater than said first angle of severity.

11. An air register as claimed in claim 10,
said inner wall having a top portion which converges towards the outer wall at a third angle of severity,
said inner wall having a bottom portion which converges towards the outer wall at a fourth angle of severity,
said fourth angle of severity being greater than said third angle of severity.

12. An air register as claimed in claim 10; and
a wick having a first portion extending at least partly into the flow passageway and a second portion extending at least partly into the trough.

13. An air register as claimed in claim 12,
said trough including a base extending between the inside and outside walls.

14. An air register as claimed in claim 13; and
a rib projecting from the base,
said rib contacting the wick.

15. An air register as claimed in claim 14,
said rib operable to at least partly inhibit shifting of the wick relative to the trough.

16. An air register as claimed in claim 10; and
a support member coupled to the inside wall and extending at least partly along the flow passageway,
said support member presenting a top surface.

17. An air register as claimed in claim 16; and
a pin protruding from the top surface and operable to at least partly inhibit shifting of the wick relative to the flow passageway.

18. A deflector couplable to an air register and operable to alter the flow direction of air exiting the register, said deflector comprising:
deflection wall adapted to extend at least partly over the outlet of the air register and presenting a lower terminal edge;
a generally planar bottom surface formed at least in part by the lower terminal edge;
a tab protruding in a first direction from the lower terminal edge;
a leg protruding generally in the first direction from the bottom surface; and
a foot extending from the bottom surface in a second direction generally opposite the first direction,
said tab, said leg, and said foot adapted to cooperatively couple the deflector to the air register.

19. A deflector as claimed in claim 18; and
a sidewall coupled to the deflection wall; and
a mounting flange coupled to the sidewall and presenting at least a portion of the bottom surface,
said leg protruding from the mounting flange.

20. A deflector as claimed in claim 18,
said deflection wall presenting a curved deflection surface adapted to contact the air exiting the register and alter its direction of flow.

21. An air register comprising:
a body defining a flow passageway and including a trough configured to hold a liquid;
a wick having a first portion extending at least partly into the flow passageway and a second portion extending at least partly into the trough;
a grill removably coupled to the body and extending at least partly over the flow passageway and the trough; and
a deflector coupled to the grill and operable to alter the direction of flow of air exiting the grill.

22. An air register as claimed in claim 21,
said grill and said body configured to provide access to the wick and the trough when the grill is removed from the body.

23. An air register as claimed in claim 22,
said grill presenting a bottom surface for contacting the first portion of the wick when the grill is coupled to the body,
said bottom surface operable to at least partly inhibit shifting of the wick relative to the body.

24. An air register as claimed in claim 21,
said body including a rib protruding from the trough and contacting the wick in the trough.

25. An air register as claimed in claim 24,
said body including a support member coupled to the trough, extending at least partly along the flow passageway, and presenting a top surface.

26. An air register as claimed in claim 25; and
a pin protruding from the top surface of the sup port member and extending at least partly in to the wick.

27. An air register as claimed in claim 26,
said rib and said pin cooperating to at least partly maintain the wick in a generally L-shaped configuration.

28. An air register as claimed in claim 21,
said trough including a pair of upper converging sidewalls and a pair of lower converging sidewalls,
said lower converging sidewalls converging at an angle of severity greater than the angle of severity of the upper converging sidewalls.

29. An air register as claimed in claim 21,
said body including only one trough.

30. An air register as claimed in claim 21,
said deflector comprising a deflection wall adapted to extend at least partly over the outlet of the air register and presenting a lower terminal edge;
a generally planar bottom surface formed at least in part by the lower terminal edge;
a tab protruding in a first direction from the lower terminal edge;
a leg protruding generally in the first direction from the bottom surface; and
a foot extending from the bottom surface in a second direction generally opposite the first direction,
said tab, said leg, and said foot cooperating to couple the deflector to the grill.

31. A method of humidifying a room having at least one floor vent for discharging air into the room, said method comprising the steps of:
(a) positioning a room humidifying assembly so that the assembly is supported on the floor surface and extends at least partly into the floor vent below the floor surface; and
(b) positioning a portion of a wick in a trough of the assembly so that the wick contacts a rib in the trough to at least partly inhibit shifting of the wick in the trough.

32. A method as claimed in claim 30; and
(c) decoupling a removable grill from a body of the room humidifying assembly.

33. A method as claimed in claim 31; and
(d) while the grill is at least partly decoupled from the body, adding water to the trough.
